(19) United States
(12) Patent Application Publication
(10) Pub. No.: US 2023/0362156 A1
(43) Pub. Date: Nov. 9, 2023

(54) SECURE TRANSFER OF HEALTH INFORMATION

(71) Applicant: ALICE HEALTH, INC., Salem, NY (US)

(72) Inventors: William P. SPENCER, Weston, MA (US); Justin C. CROWLEY, Pittsburgh, PA (US); Mark M. SMITH, Amherst, NH (US); Kimberly M. REDDINGTON, Gilbert, AZ (US)

(21) Appl. No.: 18/025,699

(22) PCT Filed: Sep. 7, 2021
(86) PCT No.: PCT/US2021/049262

§ 371 Date: Mar. 10, 2023

Related U.S. Application Data
(60) Provisional application No. 63/076,507, filed on Sep. 10, 2020.

(51) Int. Cl. H04L 9/40

(52) U.S. Cl. CPC H04L 63/0846; H04L 63/0492

(57) ABSTRACT

In various embodiments, systems and methods for the secure transfer of health information are disclosed. In some aspects, health information can be transferred directly to a device of a healthcare provider in an automated manner by communicating a transaction token or other identifier to a device of the healthcare provider, such as a Quick Response (QR) code, barcode, or the like.

### CROSS-REFERENCE TO RELATED APPLICATION

This application is a U.S. National Stage application of PCT/US2021/049262, filed Sep. 7, 2021, which claims the benefit of U.S. Provisional Application No. 63/076,507, filed on Sep. 10, 2020, both entitled “SECURE TRANSFER OF HEALTH INFORMATION,” by Spencer, et al., each of which is incorporated herein by reference.

### TECHNICAL FIELD

The present disclosure relates generally to communication systems and, more specifically, to the secure transfer of health information.

### BACKGROUND

It is becoming increasingly difficult to ensure that healthcare providers have access to the full set of health information regarding a patient. Indeed, privacy laws such as the Health Insurance Portability and Accountability Act (HIPAA), have greatly restricted the sharing of health information about a patient among healthcare providers. Even with such laws in place, patients may also be unwilling to share information with a healthcare provider out of fear of the information being stored permanently, being shared with unauthorized entities, and the like.

In further instances, a person other than the patient may also wish to convey information about the patient to the healthcare provider, but in a discrete manner. For example, a relative of a patient suffering from Alzheimer's disease may wish to convey information about the patient to the healthcare provider, but outside of earshot of the patient, so as not to upset the patient.

From the perspective of the healthcare provider, documenting information about a patient can also be quite cumbersome and prone to errors. Notably, a burden is often placed on the healthcare provider to enter the conveyed information about the patient into the patient's file. However, this can lead to some of the information about the patient not being entered or entered incorrectly.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 shows an example communication system for the secure transfer of health information;

FIG. 2 illustrates an example device;

FIGS. 3A-3C illustrate an example of the transfer of health information between devices;

FIGS. 4A-4B illustrate example sequence diagrams of the transfer of health information between devices; and

FIG. 5 illustrates an example simplified procedure for sharing health information regarding a medical patient.

In the figures, reference numbers refer to the same or equivalent parts of the present invention throughout the several figures of the drawing.

### SUMMARY

According to the techniques described herein, systems and methods for the secure transfer of health information are disclosed. In some aspects, health information can be transferred directly to a device of a healthcare provider in an automated manner by communicating a transaction token or other identifier to a device of the healthcare provider, such as a Quick Response (QR) code, barcode, or the like.

In some embodiments, a method is disclosed herein. The method includes receiving, at a server and from a first device, a request to transfer health information regarding a medical patient. The method also includes generating, by the server, a scannable code with a unique, embedded Uniform Resource Link (URL) that points to the health information. The method further includes sending, by the server, the scannable code with the unique URL to the first device, wherein a second device scans the scannable code from the first device. The method additionally includes receiving, at the server and via the URL, a request for the health information from the second device. The method also includes providing, by the server, the health information regarding the medical patient to the second device.

In one embodiment, the scannable code comprises a Quick Response (QR) code or near field communication (NFC) encoding. In another embodiment, the request for the health information includes a transaction token with a set expiration time, and wherein the server denies the request for the health information from the second device, when the transaction token is expired. In yet another embodiment, the method also includes denying a subsequent request for the health information from the second device, based on the second device having already accessed the health information via the unique URL. In a further embodiment, the method additionally includes determining, by the server, a physical distance between the first device and the second device, wherein the server provides the health information regarding the medical patient to the second device when the physical distance between the first device and the second device is below a defined threshold. These space and time-limited strategies may be enforced by repeated browser refreshes, or the like.

In another embodiment, the health information includes environmental information regarding a living environment of the medical patient. In yet another embodiment, the environmental information indicates living conditions of the medical patient or a presence of a pet in their living environment.

In a further embodiment, the health information includes behavioral information regarding the medical patient. In another embodiment, the behavioral information indicates a diet of the medical patient or a mood of the medical patient.

In yet another embodiment, the health information includes information about a friend or family member of the medical patient.

In another embodiment, the method also includes receiving, at the server and from the first device, at least a portion of the health information regarding the medical patient.

In an additional embodiment, the request for the health information received from the second device includes credentials for a user of the second device, and the method further includes determining, by the server and based on the credentials, whether the user of the second device is authorized to view the health information. In one embodiment, the credentials include a geolocation of the second device. In another embodiment, the credentials indicate an institution associated with the user of the second device.

In some embodiments, the method includes providing, by the server and to the second device, identity information for the medical patient, in response to the request for the health information, wherein the server provides the health information regarding the medical patient to the second device, in response to a confirmation of the identity information by a user of the second device. In one embodiment, the identity information includes a picture of the medical patient.

In further embodiments, the method also includes forwarding, by the server and to the first device, a request from the second device to re-access the health information regarding the medical patient; and re-providing, by the server, the health information to the second device, when the first device authorizes the request from the second device to re-access the health information. In yet another embodiment, the method also includes generating, by the server, a transaction token associated with the health information, wherein the unique URL includes the transaction token.

In various embodiments, an apparatus is disclosed herein. The apparatus includes a network interface to communicate with a computer network, a processor coupled to the network interface and configured to execute one or more processes, and a memory configured to store a process that is executed by the processor. When executed, the process is configured to receive, from a first device, a request to transfer health information regarding a medical patient; generate a scannable code with a unique, embedded Uniform Resource Link (URL) that points to the health information; send the scannable code with the unique URL to the first device, wherein a second device scans the scannable code from the first device; receive, via the URL, a request for the health information from the second device; and provide the health information regarding the medical patient to the second device.

In additional embodiments, a tangible, non-transitory, computer-readable medium storing program instructions is disclosed. The program instructions cause a server to execute a process including: receiving, at the server and from a first device, a request to transfer health information regarding a medical patient; generating, by the server, a scannable code with a unique, embedded Uniform Resource Link (URL) that points to the health information; sending, by the server, the scannable code with the unique URL to the first device, wherein a second device scans the scannable code from the first device; receiving, at the server and via the URL, a request for the health information from the second device; and providing, by the server, the health information regarding the medical patient to the second device.

Other specifics and embodiments are further described herein, and this summary is not meant to be limiting to scope of the present disclosure.

### DETAILED DESCRIPTION

To provide an overall understanding of the invention, certain illustrative embodiments will now be described.

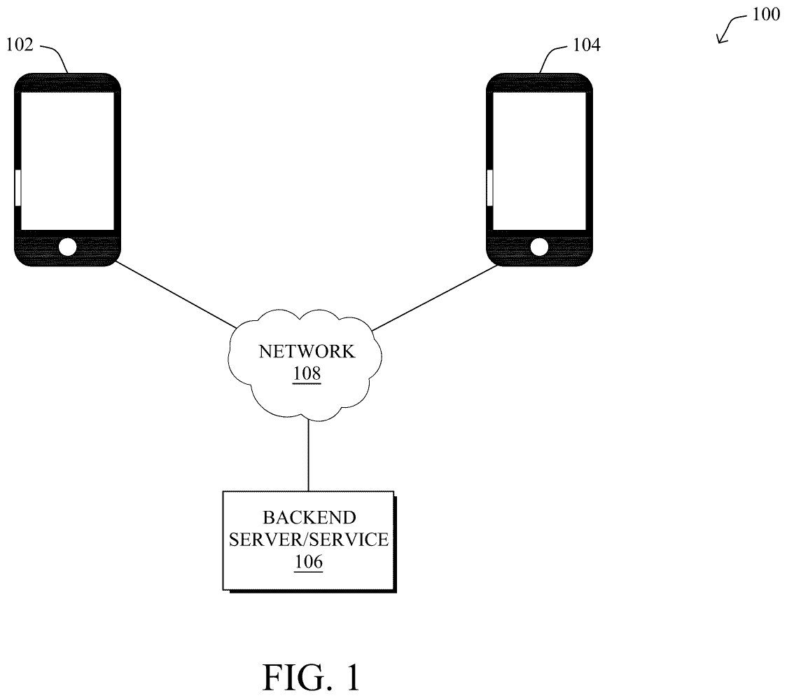

FIG. 1 shows an example communication system 100 for the secure transfer of health information, according to various embodiments. As shown, system 100 may include any or all of the following components: a first device 102, a second device 104, a backend server/service 106, and a network 108 that provides connectivity between backend server/service 106 and devices 102-104.

In general, devices 102-104 may comprise computing devices capable of storing, processing, and communicating data. For instance, devices 102-104 may comprise mobile phones, tablets, wearable electronic devices (e.g., smart watches, smart glasses, etc.), desktop computers, or any other known form of device capable of performing the techniques herein.

During operation, device 102, device 104, and server/service 106 may be communicatively coupled with one another, either directly or indirectly, such as by leveraging a communication infrastructure that forms network 108. For instance, device 102, device 104, and server/service 106 may communicate with one another via the Internet or form of network 108. Accordingly, network 108 may comprise any number of wide area networks (WANs), local area networks (LANs), personal area networks (PANs), and/or direct network connections between any of these components.

More specifically, example network connections and infrastructure used by device 102, device 104, and server/service 106 may include, but are not limited to, connections that leverage wireless approaches such as Wi-Fi, cellular, satellite, and the like, and/or wired approaches such as Ethernet, cable Internet, fiber optics, and the like. In further embodiments, devices 102-104 may communicate directly with one another using a shorter-range communication approach, such as via Bluetooth, Z-Wave, ZigBee, 6LoWPAN, other near field communication (NFC) approaches, infrared, visible light, or the like. In yet another embodiment, one of devices 102-104 may provide connectivity to network 108 on behalf of the other, essentially acting as a communications relay.

Backend server/106 may comprise one or more servers that provide a service configured to facilitate the transfer of heath information between devices 102-104. For instance, assume that device 102 is operated by a patient or other user having access to information about the patient, such as a friend, relative, or guardian of the patient. Conversely, for purposes of describing the techniques herein, assume that device 104 is operated by a healthcare provider, such as a doctor, nurse, pharmacist, chiropractor, nursing or retirement home staff, hospital staff, massage therapist, physical or occupational therapist, wellness provider, or other user operating device 104 on behalf of a healthcare provider. During use, communication system 100 allows the user of device 102 to transfer health information to device 104 in a secure and controlled manner.

In general, the health information communicated between device 102 and device 104 may take the form of any or all of the following: images, video recordings, audio recordings, text, database information, charts or graphs, or the like. Typically, the health information may be indicative of the prior or current health state of the patient. For instance, the health information may include a log of when the patient experienced vertigo over a period of time. However, the health information is not limited to explicit indications of health conditions and may also include environmental information (e.g., the living conditions of the patient, the presence of pets, etc.), behavioral information (e.g., the diet of the patient, the mood of the patient, etc.), the social history of the patient (e.g. marriage, divorce, births or deaths of family members, employment status, household membership, history of abuse or trauma, etc.), family history of potentially heritable disease (e.g. cancer or genetic anomalies present in parents or grandparents, etc.), or other (PII or other) information that may influence the health of the patient or be pertinent to an evaluation of the health of the patient by the healthcare provider.

Note that while the term ‘health information’ is used herein to describe the operation of the system, the system is not limited as such and other types of information can also be communicated between device that may not fall under any medical privacy laws, regulations or policies. For instance, additional information that can be communicated regarding the patient may include information about the friends or family members of the patient (e.g., upcoming birthdays, travel plans to visit the patient, pictures of the patient, friend, or family member, etc.), interests of the patient (e.g., favorite television shows, a playlist of favorite songs, hobbies, etc.), other information that can be used to improve the mood of the patient, or the like. Accordingly, the term ‘health information’ herein is intended to refer to this type of information, as well, unless expressly limited from doing so.

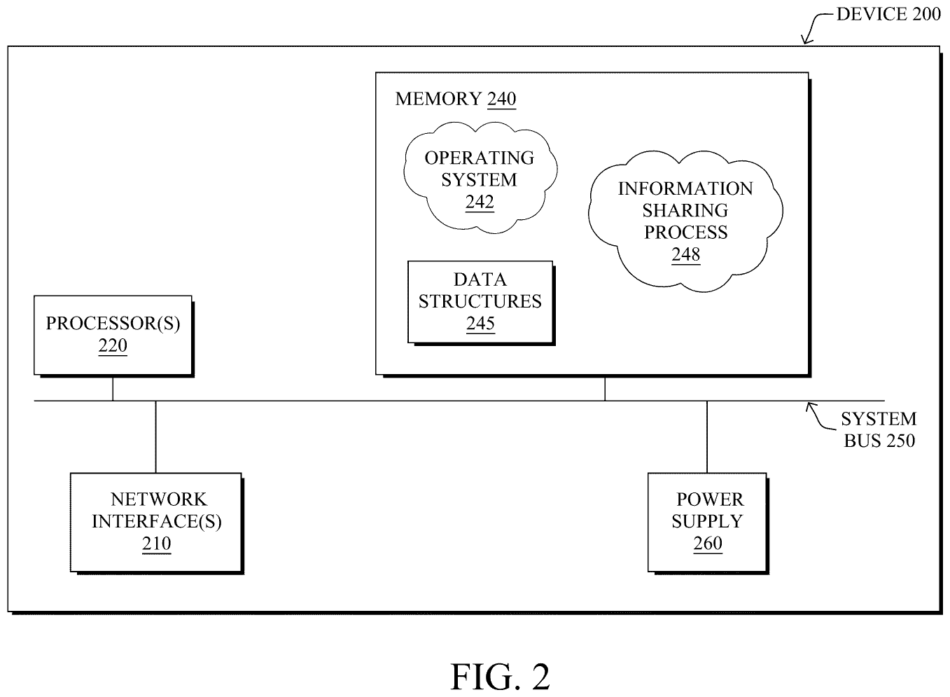

FIG. 2 is a schematic block diagram of an example device 200 (e.g., an apparatus) that may be used with one or more embodiments described herein, e.g., any of the devices shown in FIG. 1 (e.g., device 102, device 104, server 106). As shown, device 200 may comprise one or more network interfaces 210 (e.g., wired, wireless, etc.), at least one processor 220, and a memory 240 interconnected by a system bus 250, as well as a power supply 260 that provides electrical power to device 200.

The network interface(s) 210 contain the mechanical, electrical, and signaling circuitry for communicating data with other computing devices, such as those shown in communication system 100 in FIG. 1. The network interfaces may be configured to transmit and/or receive data using a variety of different communication protocols. Note, further, that device 200 may have two different types of network connections, e.g., wireless and wired/physical connections, and that the view herein is merely for illustration.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise an information sharing process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, where certain processes have been shown separately, those skilled in the art will appreciate that processes may be routines or modules within other processes.

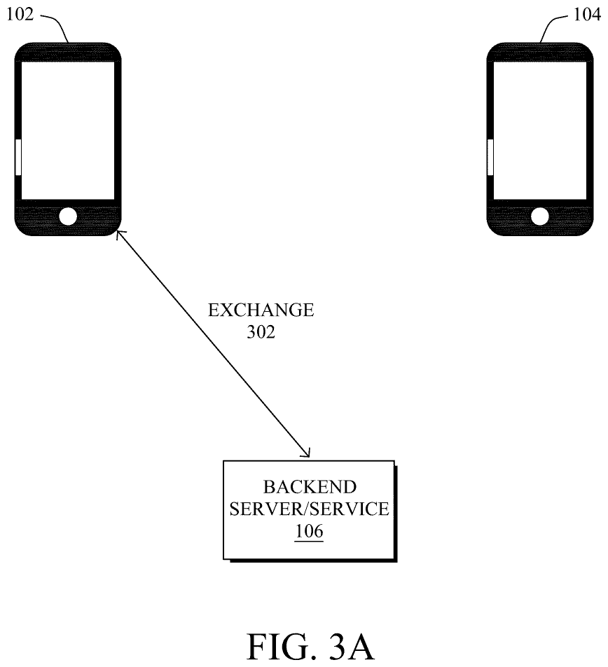

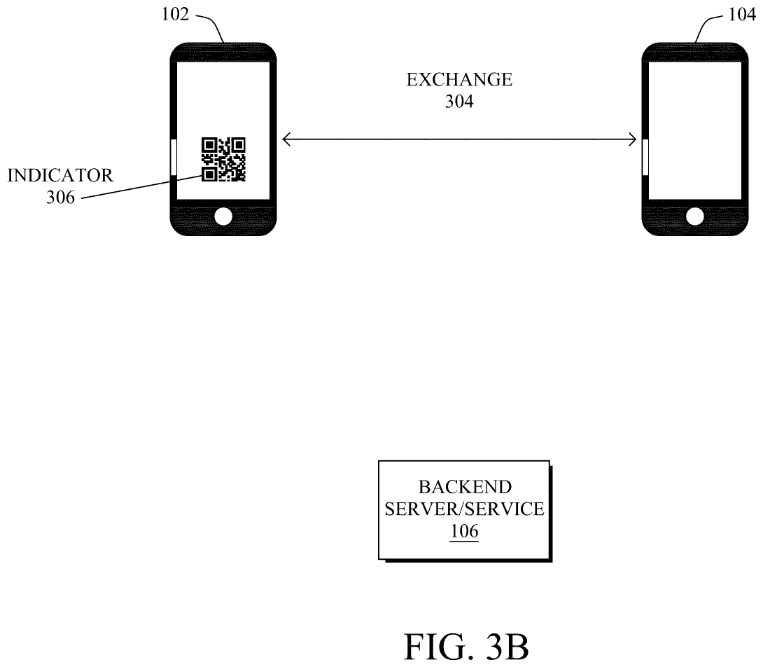

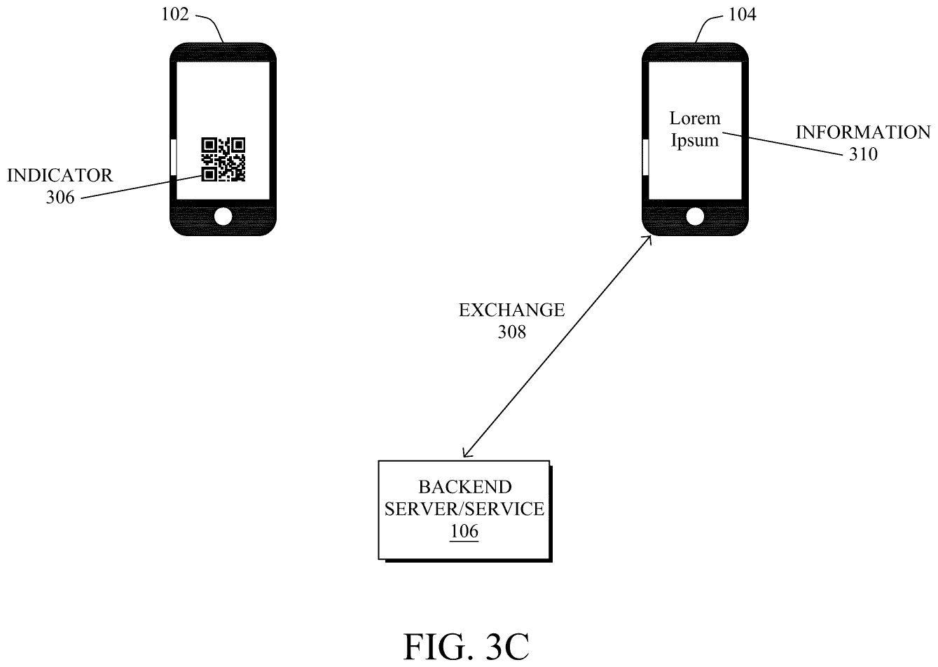

FIGS. 3A-3C illustrate an example of the transfer of health information between devices, according to various embodiments. As shown in FIG. 3A and continuing the previous example in FIG. 1, assume that device 102 is operated by a patient or person associated with the patient and wishes to transfer health information regarding the patient to device 104, which is operated by a healthcare provider. To initiate the transfer, device 102 may perform an exchange 302 with backend server/service 106 (e.g., via the network 108 shown in FIG. 1.).

Generally speaking, exchange 302 may include a request sent by device 102 to backend server/service 106 indicative of a desire to share healthcare information with device 104. To this end, the request may include authentication for the user of device 102 (e.g., login information, biometrics, etc.), an identifier associated with the patient (e.g., a patient ID, etc.), and/or an identifier for device 104 with which the health information is to be shared. Such an identifier for device 104 may be preconfigured, entered manually by the user of device 102, or transferred from device 104 to device 102 (e.g., via Bluetooth, an on-screen code, etc.). In another embodiment, exchange 302 may be initiated by device 102 through the use of a voice command and/or virtual assistant, such as Siri™, Alexa™, or the like.

In a further embodiment, device 102 may send the information to be shared with device 104 to backend server/service 106 as part of exchange 302. In other embodiments, device 102 may send the information to be shared with device 104 to backend server/service 106 prior to exchange 302 or after exchange 302 completes.

In response to the request from device 102, backend server/service 106 may generate a transaction-specific code for the sharing of the information with device 104 and provide this code to device 104 as part of exchange 302. In various embodiments, the code may be a scannable code that takes the form of a Quick Response (QR) code, a barcode, or other information associated with the transaction that may be shared by device 102 with device 104.

According to various embodiments, the scannable code generated by service 106 may also include an embedded Uniform Resource Locator (URL) that can be used to access the health information to be shared. In some embodiments, such a URL may be a unique URL that includes token information associated with the health information.

In FIG. 3B, device 102 may perform an exchange 304 with device 104 during which device 102 sends the transaction identifier that it received from backend server/service 106 to device 104. For instance, in one embodiment, device 102 may display scannable code 306, such as a QR code, barcode, or the like, representative of the transaction identifier. In turn, a camera or other sensor of device 104 may read code 306, thereby transferring the transaction information to device 104, such as the URL at which device 104 can access the health information for the patient in question.

In an alternate embodiment, NFC or other wireless communication means may be employed to transmit the transaction information from device 102 to device 104. For instance, the users of device 102 and device 104 may do so via ‘bumping’ or putting the two devices within close proximity of one another. This may be performed, for instance, through the execution of respective applications by device 102 and device 104, which may first be placed into sharing states of operation.

In some embodiments, device 102 and device 104 may also employ background tag reading, which allows tags to be scanned quickly, without needing to first open the corresponding app or manually initiating scanning. On devices that support this functionality, the device may automatically look for nearby compatible tags, whenever the screen is illuminated. After detecting and matching a tag with an app, the device may present a notification to the user that can be confirmed by the user (e.g., via tapping, voice command, etc.), to send the tag data to the app for processing. Note that background reading is typically disabled when the device is in certain states such as when an NFC scanning sheet is visible, Wallet™ or Apple Pay™ are in use, cameras are in use, the device is in airplane mode, or the device is locked after a restart.

In FIG. 3C, once device 104 has obtained the transaction information, it may initiate its own exchange 308 with backend serer/service 106, according to various embodiments. In some embodiments, backend server/service 106 may first provide verification information to device 104, allowing the user of device 104 to verify the identity of the patient whose information is to be shared. For instance, backend server/service 106 may provide a picture of the patient, the date of birth of the patient, or other such information to device 104, allowing the user of device 104 to first verify that the transaction is for the correct patient. In a further embodiment, such a verification may involve the patient and/or user of device 102, to ensure that the transaction information is correct.

In various embodiments, exchange 308 may also result in healthcare information being passed from device 102 to device 104, either directly or via backend server/service 106. For instance, in some embodiments, device 102 may send the healthcare information regarding the patient to backend server/service 106, which then sends the information on to device 104 as part of exchange 308. In another embodiment, exchange 308 may authorize device 104 to receive the healthcare information directly from device 102.

In some embodiments, one or more constraints may be placed on the sharing of information from device 102 to device 104. Indeed, in one embodiment, a time limit may be imposed on the sharing of the health information with device 104. For instance, device 104 may only be allowed to access the health information for a preconfigured amount of time, such as for fifteen minutes. This can be implemented by placing a time limit on the transaction identifier/token information shared with device 104, disabling the access to the information by device 104 after expiration of the time period, and/or causing device 104 to delete the shared information after the specified amount of time.

In a further embodiment, another constraint that may be placed on the shared health information may include a geofence or proximity with device 102 imposed on the information. For instance, device 104 may be prevented from accessing the health information, if it is more than n-number of feet away from device 102, and/or causing device 104 to delete the shared health information when outside this range.

In cases in which a constraint is imposed on the shared health information, device 104 may be allowed to request access again to the health information. For instance, if device 104 is locked out of the health information due to a timeout, moving outside of the allowed range of device 102, or the like, device 104 may send a request to re-access the information, which may be approved by backend server/service 106 (e.g., based on one or more parameters) or device 102 (e.g., allowing the user of device 102 to approve the additional access).

Note that there may also be a distinction maintained by backend server/service 106 with respect to information protected by law, regulation, or policy, and information that is not. For instance, backend server/service 106 may employ differentiated levels of access to different individuals, based on their credentials. In addition, backend server/service 106 may apply different policies to the access, such as by allowing access for different amounts of time, different distance ranges, or other access parameters.

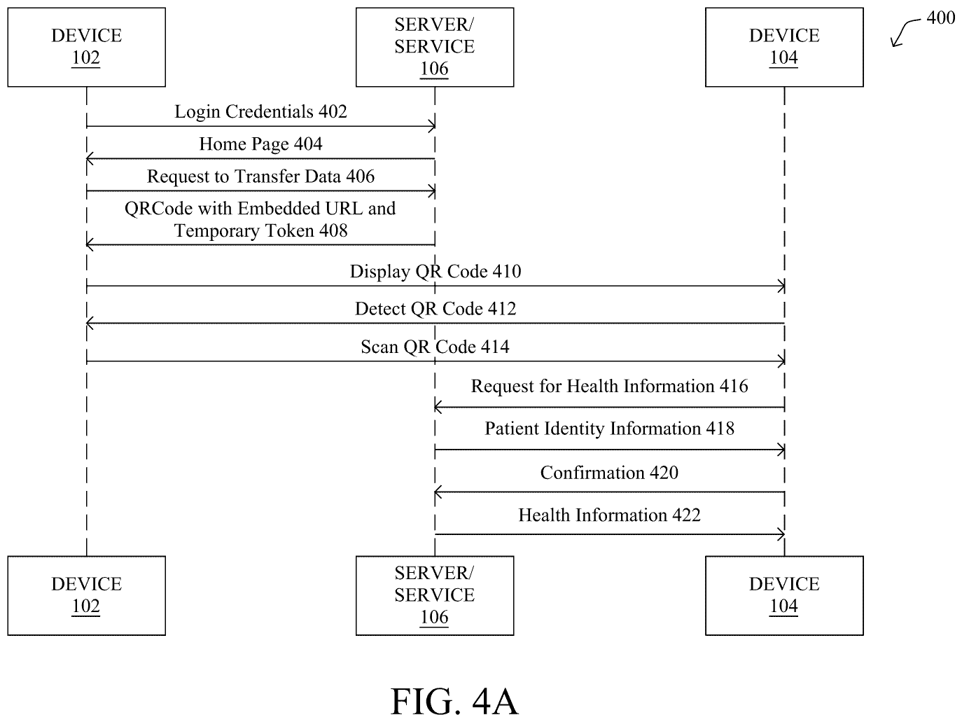

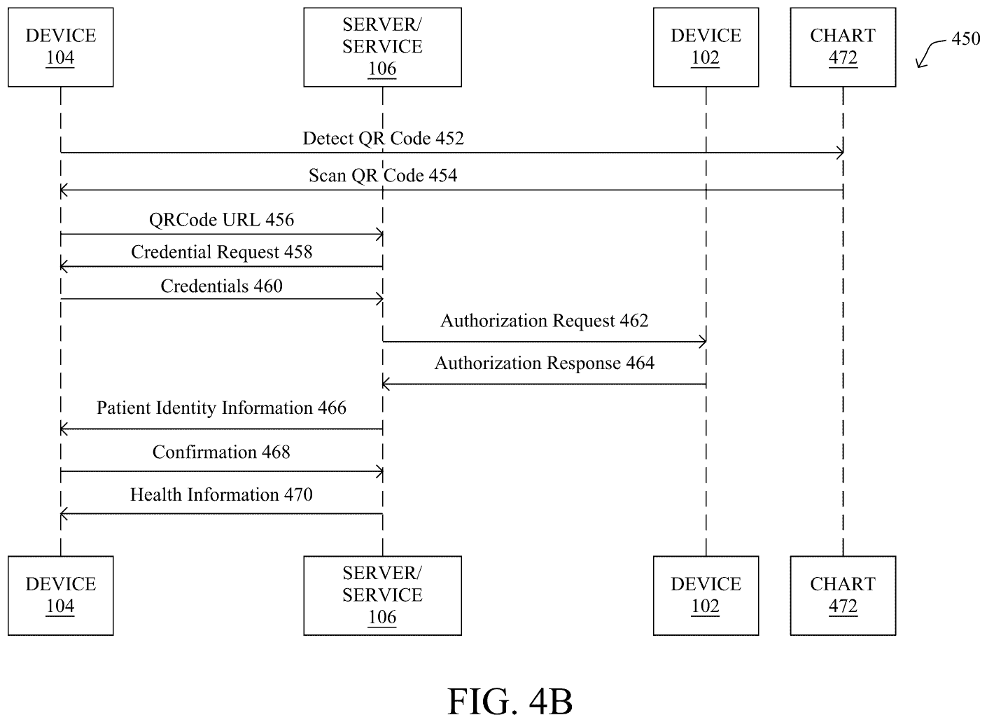

FIGS. 4A-4B illustrate example sequence diagrams of the transfer of health information between devices, according to various embodiments. More specifically, FIG. 4A illustrates an example sequence diagram 400 for an embodiment that uses a QR code or other scannable code to share health information from device 102 to device 104. Conversely, FIG. 4B illustrates an alternate example sequence diagram 410 for the use of a QR code or other transaction identifier to share health information from device 102 to device 104.

As shown in FIG. 4A, an information sharing transaction may begin by device 102 providing login credentials 402 to backend server/service 106. As would be appreciated, all exchanges between device 102, device 104, and/or backend server/service 106 may employ encryption, to protect the communications from outside access. For instance, the communications may employ Transport Layer Security (TLS), an authentication mechanism such as public key infrastructure (PKI), or the like, to protect the transaction from interlopers and other malicious entities.

If backend server/service 106 verifies the identity of device 102 from the provided login credential, backend server/service 106 may return a home page 404 to device 102, allowing device 102 access to the information sharing service of backend server/service 106. In other embodiments, portions of the homepage 404 may be stored directly on device 102, such as part of a pre-installed application (“app”) executed by device 102. In either case, device 102 may present a home screen or page of the information sharing service to the user of device 102.

The user of device 102 may then indicate a desire to share health information with device 104 to backend server/service 106, by sending a request to transfer the health information. In addition, request 406 may, for instance, identify device 104 or the user of device 104, such as the identity of a particular doctor or other healthcare provider with whom the health information is to be shared.

In response to request 406 from device 102, backend server/service 106 may generate transaction information and return it to device 102. For instance, backend server/service 106 may generate and return a QR code 408 with an embedded URL and temporary token for the transaction to device 102. In other embodiments, backend server/service 106 may generate computer code that can be scanned, wirelessly, such as an NFC message. In some instances, the token may also have one or more associated constraints, such as expiring after a preset time interval, when device 104 is outside of some distance of device 102 (e.g., one hundred feet), and/or the first time use of the QR code, NFC code, etc. (e.g., to allow the user of device 104 to access the health information only once).

To convey the QR code 408 from device 102 to device 104, the user of device 102 may present the display of device 102 to the user of device 104. More specifically, at step 410, the user of device 102 may operate device 102 to show QR code 408 on a display of device 102. In turn, at step 412, the user of device 104 may operate its camera to view QR code 408. This allows device 104 to read QR code 408, at step 414, thereby conveying the transaction information from device 102 to device 104. In other embodiments, as described above, the data transferred to device 104 may be conveyed via NFC or other wireless connection, via a barcode or other visual indicia, or the like.

Once device 104 has obtained QR code 408 or other transaction information from device 102, device 104 may send a request 416 to service 106 for the health information associated with the patient. For instance, device 104 may send the request to the unique URL embedded in QR code 408 obtained from device 102. In various embodiments, request 416 may also include any token information conveyed to device 104 for the transaction, as well. In doing so, this allows backend server/service 106 to associate device 104 with the transaction. In further embodiments, request 416 may also include credential information for the user of device 104, allowing service 106 to determine whether the user has sufficient privileges to view the health information for the medical patient.

In response, in some cases, backend server/service 106 may return identification information 418 for the patient to device 104, so that the user of device 104 can verify that the correct transaction is being performed. For instance, backend server/service 106 may return a picture of the patient, the date of birth (DoB) of the patient, etc., to device 104 for confirmation. If the provided information is correct, device 104 may confirm the identity information 418 by sending confirmation 420 to backend server/service 106. If confirmed, service 106 may grant device 104 access to the health information of the patient identified by identification information 418 and send the requested health information 422 to device 104 for review.

During access, the user of device 104 may be allowed to search through the health information 422 regarding the patient. For instance, the user of device 104 may review pictures of discharge notes from previous doctor visits, pictures of prescriptions, timelines of various significant medical events, patient social history information, etc., which may be provided to backend server/service 106 by device 102 and/or other devices on behalf of the patient.

FIG. 4B illustrates an alternate example sequence diagram 450 for the use of a QR code or other transaction information, to share health information from device 102 to device 104, according to various embodiments. In some embodiments, a QR code or other identifier may be affixed to a physical medical record, such as chart 472, that is associated with the patient. Similar to the QR code shared by device 102 with device 104 in sequence diagram 410 in FIG. 4A, the QR code or other identifier affixed to chart 472 may be associated with a particular transaction facilitated by service 106. For instance, assume for purposes of illustration that device 102 and service 106 have already negotiated a sharing transaction and that service 106 has generated a QR code or other transaction information associated with the health information for the patient in question.

Here, in contrast to sequence diagram 400, such a QR code may be affixed physically to chart 472, instead of being shared directly between device 102 and device 104. Note, however, that alternate embodiments provide for the operations depicted in alternate example sequence diagram 450 to be performed using a sharing mechanism between device 102 and device 104.

As shown, device 104 may detect the QR code affixed to chart 474, such as by the doctor or other healthcare worker operating device 104 pointing a camera or other scanner at the code (step 452). In turn, at step 454, device 104 may scan the QR or other code, to obtain the transaction information needed to retrieve the health information for the patient. Thus, similar to sequence diagram 400, device 104 may then send a request to service 106 for the healthcare information associated with the patient, such as to a URL embedded into the scanned QR code.

In some embodiments, since the QR or other scannable code was not presented directly to the healthcare worker by the person sharing the health information, additional steps may also be taken to ensure that the user of device 104 is authorized to access that information. For instance, in response to request 456, service 106 may send a credential request 458 back to device 104, requesting the credentials of the user of device 104. In turn, device 104 may send credentials 460 back to service 106, such as the name of its user or other login information, the institution of its user, geocoordinates of device 104, or the like.

Backend server/service 106 may use the provided credential information to verify that the user of device 104 is authorized to access the health information for the patient, such as by comparing the provided information to a medical provider database, a known location of a medical institution, the age of the token on chart 472, determining whether the user was a previously known user, etc.

In further embodiments, service 106 may also send an authorization request 462 to device 102. In general, authorization request 462 may indicate the identity of the user of device 104 (e.g., based on their supplied credentials 460), as well as an indication of the health information that they are seeking to access. This allows the supplier of the health information to control when that information is shared, as well as with whom. Thus, if device 102 rejects authorization request 462, service 106 may notify device 104 that its user has been denied access to the health information. Conversely, if the user of device 102 authorizes the access, it may respond to service 106 with authorization response 464 indicating that the user of device 104 is authorized.

Similar to sequence diagram 400, as shown, service 106 may also ask the user of device 104 to confirm the identity of the patient, before providing their health data to device 104. To do so, service 106 may send patient identity information 466 to device 104, such as a picture of the patent, the name of the patient, etc. If the patient matches, the user of device 104 may send a confirmation 468 back to service 106. In turn, service 106 may provide the requested health information 470 to device 104 for review. Of course, if the user of device 104 fails to confirm the identity of the patient, or indicates that the information is wrong, backend server/service 106 may prevent the user of device 104 from accessing the health information and/or raise an error alert.

Once the user of device 104 has access, they may perform any or all of the tasks detailed with respect to FIG. 4A, such as searching for information, accessing pictures of discharge notes, prescriptions, etc.

By way of example of operation, assume that a relative of the patient has a playlist of favorite songs of the patient. By sending this information to backend server/service 106, a healthcare provider can access this information in a secure manner using the techniques herein. This allows the healthcare provider to play the playlist for the patient, thereby comforting the patient.

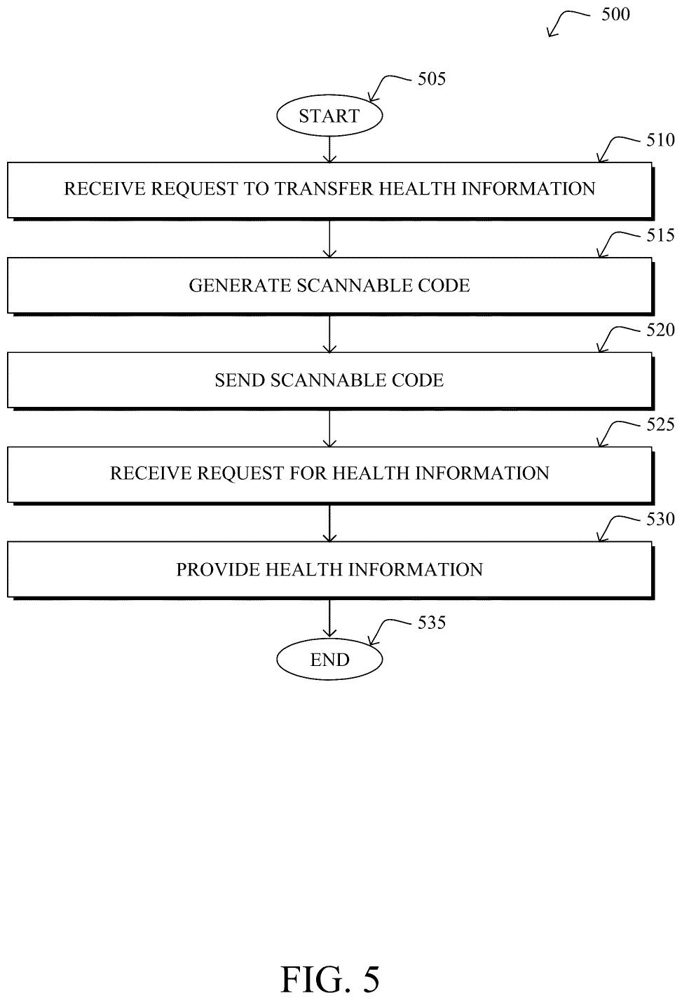

FIG. 5 illustrates an example simplified procedure for sharing health information regarding a medical patient, according to various embodiments. For example, a non-generic, specifically configured server (e.g., device 200) may perform procedure 500 by executing stored instructions (e.g., information sharing process 248). The procedure 500 may start at step 505, and continues to step 510, where, as described in greater detail above, the server may receive a request to transfer health information regarding a medical patient. As noted above, the health information may also include environmental information about the patient (e.g., their living conditions, the presence of a pet, etc.), behavioral information regarding the patient (e.g., their diet, mood, etc.), the social history of the patient (e.g. marriage, divorce, births or deaths of family members, employment status, household membership, history of abuse or trauma, etc.), family history of potentially heritable disease (e.g. cancer or genetic anomalies present in parents or grandparents, etc.), information about a friend or family of the patient (e.g., scheduled time with the patient, etc.), combinations thereof, or the like.

At step 515, as detailed above, the server may generate a scannable code with a unique, embedded URL that points to the health information. In some embodiments, the scannable code may comprise a QR code, barcode, NFC encoding that can be scanned, or the like. In further embodiments, the server may also generate a transaction token in conjunction with the URL (e.g., embedded into the URL or provided separately). The token may, for instance, impose conditions on the access to the health information, such as a single use token, a token that is only usable within a certain geofence or proximity of the first device, a time limit to access the health information, etc.

At step 520, the server may send the scannable code to the first device, as described in greater detail above. In turn, a second device may scan the code. In one embodiment, the second device may scan the code directly from the first device, such as by capturing an image of the code using a camera (e.g., as in the case of a QR code) or receiving the code wirelessly, such as via NFC (e.g., Apple Airdrop, etc.). In another embodiment, the second device may scan the code from a physical object to which the code may be attached, such as a medical record of the patient.

At step 525, as detailed above, the server may receive a request for the health information from the second device, via the URL. For instance, in response to scanning the code, a web browser of the second device may redirect it to the URL. In some instances, such as when the URL includes a transaction token, this allows the server to identify the particular transaction and the specific patient information to be shared with the user of the second device.

At step 530, the server may provide the health information regarding the medical patient to the second device, as described in greater detail above. In doing so, this allows the user of the first device to securely share health information about the patient with the user of the second device. For instance, a caretaker of the patient (e.g., a friend, relative, etc.) may use the above approach to securely share information that they have about the patient with a medical professional. Procedure 500 then ends at step 535.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

As will be appreciated, the above examples are intended only for the understanding of certain aspects of the techniques herein and are not limiting in nature. While the techniques are described primarily with respect to a particular device or system, the disclosed processes may be executed by other devices according to further implementations. For example, while the techniques herein are described primarily with respect to the secure sharing of health information, the techniques herein are not limited as such and can be adapted for use in other industries, as well.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. For example, control of the current to the housing coil(s) may be computer controlled, in some embodiments. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
receiving, at a server and from a first device, a request to transfer health information regarding a medical patient;
generating, by the server, a scannable code with a unique, embedded Uniform Resource Link (URL) that points to the health information;
sending, by the server, the scannable code with the unique URL to the first device, wherein a second device scans the scannable code;
receiving, at the server and via the URL, a request for the health information from the second device; and
providing, by the server, the health information regarding the medical patient to the second device.

2. The method as in claim 1, wherein the scannable code comprises a Quick Response (QR) code or near field communication (NFC) encoding.

3. The method as in claim 1, wherein the request for the health information includes a transaction token with a set expiration time, and wherein the server denies the request for the health information from the second device, when the transaction token is expired.

4. The method as in claim 1, further comprising:
denying a subsequent request for the health information from the second device, based on the second device having already accessed the health information via the unique URL.

5. The method as in claim 1, further comprising:
determining, by the server, a physical distance between the first device and the second device, wherein the server provides the health information regarding the medical patient to the second device when the physical distance between the first device and the second device is below a defined threshold.

6. The method as in claim 1, wherein the health information includes environmental information regarding a living environment of the medical patient.

7. The method as in claim 6, wherein the environmental information indicates living conditions of the medical patient or a presence of a pet in their living environment.

8. The method as in claim 1, wherein the health information includes behavioral information regarding the medical patient.

9. The method as in claim 8, wherein the behavioral information indicates a diet of the medical patient or a mood of the medical patient.

10. The method as in claim 1, wherein the health information includes information about a friend or family member of the medical patient.

11. The method as in claim 1, further comprising:
receiving, at the server and from the first device, at least a portion of the health information regarding the medical patient.

12. The method as in claim 1, wherein the request for the health information received from the second device includes credentials for a user of the second device, the method further comprising:
determining, by the server and based on the credentials, whether the user of the second device is authorized to view the health information.

13. The method as in claim 12, wherein the credentials include a geolocation of the second device.

14. The method as in claim 12, wherein the credentials indicate an institution associated with the user of the second device.

15. The method as in claim 1, further comprising:
providing, by the server and to the second device, identity information for the medical patient, in response to the request for the health information, wherein the server provides the health information regarding the medical patient to the second device, in response to a confirmation of the identity information by a user of the second device.

16. The method as in claim 15, wherein the identity information includes a picture of the medical patient.

17. The method as in claim 1, further comprising:
forwarding, by the server and to the first device, a request from the second device to re-access the health information regarding the medical patient; and
re-providing, by the server, the health information to the second device, when the first device authorizes the request from the second device to re-access the health information.

18. The method as in claim 1, further comprising:
generating, by the server, a transaction token associated with the health information, wherein the unique URL includes the transaction token.

19. An apparatus, comprising:
a network interface to communicate with a computer network;
a processor coupled to the network interface and configured to execute one or more processes; and
a memory configured to store a process that is executed by the processor, the process when executed configured to:
receive, from a first device, a request to transfer health information regarding a medical patient;
generate a scannable code with a unique, embedded Uniform Resource Link (URL) that points to the health information;
send the scannable code with the unique URL to the first device, wherein a second device scans the scannable code;
receive, via the URL, a request for the health information from the second device; and
provide the health information regarding the medical patient to the second device.

20. A tangible, non-transitory, computer-readable medium storing program instructions that cause a server to execute a process comprising:
receiving, at the server and from a first device, a request to transfer health information regarding a medical patient;
generating, by the server, a scannable code with a unique, embedded Uniform Resource Link (URL) that points to the health information;
sending, by the server, the scannable code with the unique URL to the first device, wherein a second device scans the scannable code;
receiving, at the server and via the URL, a request for the health information from the second device; and
providing, by the server, the health information regarding the medical patient to the second device.
